(19) United States
(12) Patent Application Publication
(10) Pub. No.: US 2002/0012431 A1
(43) Pub. Date: Jan. 31, 2002

(54) Encryption system using light interference theory

(76) Inventor: Zhixing Wang, Chiba-shi (JP)

Correspondence Address: NIRO, SCAVONE, HALLER & NIRO, Suite 4600, 181 W. Madison Street, Chicago, IL, 60602, US

(21) Appl. No.: 09/884,427

(22) Filed: Jun. 19, 2001

(30) Foreign Application Priority Data
Jun. 22, 2000 (JP) 2000-226083

(51) Int. Cl. H04L 9/00

(52) U.S. Cl. 380/54; 380/44

(57) ABSTRACT

This system segments and converts a cryptograph key into two digital optical signals with amplitudes, wavelengths, and initial phases, and an initial aberration (optical path length difference) at a point P where the two digital optical signals meet.

The luminance of light at the interference fringe at point P changes dynamically as the aberration between the two digital optical signals changes, based on the interaction between the two digital optical signals. Using the luminance of light at the interference fringe at point P as a random number, then the ciphertext will be generated by XOR (Exclusive OR) operations between the plaintext and the random number determined by the luminance of light at point P. The invention thus implements a high speed, secure cryptographic system using the random number determined by the luminance.

### BACKGROUND OF THE INVENTION

The present invention relates generally to encryption systems, and more particularly, to an encryption system that is implemented using the concepts of light interference theory.

The Data Encryption Standard (DES) and Rivest Shamir Aldeman (RSA) cryptographic systems are two of the best known and most widely used cryptographic systems. The effective size of the cryptograph key of the DES system is 56 bit. As a result, the DES system is relatively insecure, because the bit size of the cryptograph key is not large. Software implementations of DES encryption are also slow due to the complexity of the system. The RSA algorithm is based on the computationally difficult problem of factoring large prime numbers, since its processes rely on complicated mathematics which execute slowly in software. Thus, software implementations of the RSA algorithm are also relatively slow. The present invention overcomes the problems of both the DES and RSA cryptographic systems by enabling a relatively fast, more secure encryption without requiring excessive computation.

### SUMMARY OF THE INVENTION

The invention is an encryption system using the mathematics of light interference theory to increase security and speed encryption. It segments and converts a 128 bit cryptograph key into two digital optical signals with amplitudes, wavelengths, initial phases, and a resulting aberration (optical path length difference) determined at point P where the two digital optical signals meet. The invention efficiently increases length of the cryptograph key.

Using a digital light interference signal generator to generate the aberration value changes dynamically, the luminance of light at the interference fringe at point P will change as the aberration changes. Using the luminance of light at the interference fringe as a random number, then the ciphertext will be generated by XOR operations between the plaintext and the random numbers determined by the luminance at point P. Since the calculations of the digital light interference signal generator are relatively simple, the encrypting and decrypting processes are sped up as a result.

The cryptographic system of the present invention can be used in secure computer systems and secure communication systems as well as other systems requiring secure, fast encryption and decryption. It can be used in relatively low cost, high performance products whether enabled in software on hardware or in embedded hardware.

### BRIEF DESCRIPTION OF THE DRAWINGS

These and other features, objects and advantages of the present invention will become apparent from the following description and drawings wherein like reference numerals represent like elements in several views, and in which:

FIG. 1 is a functional block diagram of the encryption and decryption system in accordance with the principles of the present invention.

FIG. 2 is a diagram showing a cryptograph key segment and the conversion process in accordance with the principles of the present invention.

FIG. 3 is a diagram showing an encryption process in accordance with the principles of the present invention.

FIG. 4 is a diagram showing a decryption process in accordance with the principles of the present invention.

FIG. 5 is a list showing a sample plaintext.

FIG. 6 is a list showing the resulting ciphertext from encryption using cryptograph key “key1”.

FIG. 7 is a list showing the same sample plaintext as used in FIG. 5.

FIG. 8 is a list showing the resulting ciphertext from encryption using cryptograph key “key2”.

### DESCRIPTION OF THE PREFERRED EMBODIMENT

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

Two digital optical signals which have the same amplitude A, wavelength λ, and initial phase Φ₀. If the aberration is ΔS at point P where the two digital optical signals meet, then the difference of the light waves at the optical path is ΔS/λ. Since the initial phase Φ₀ of the two digital optical signals is the same, then the difference of phases at point P where the two digital optical signals meet is ΔΦ=2π*ΔS/λ.

For example, the displacement of the two digital optical signals at point P where they meet (y1 and y2) can be expressed as follows:

y1=A sin (ωt+π*ΔS/λ+Φ₀)

y2=A sin (ωt−π*ΔS/λ+Φ₀)

where, ω is angular speed, and t is time. The light interference (Y) of the two digital optical signals at point P, when the displacements of the two digital optical signals are combined, is expressed as the following, where Y=y1+y2:

A sin (ωt+π*ΔS/λ+Φ₀)+A sin (ωt−π*ΔS/λ+Φ₀) =2A sin ((2ωt+2Φ₀)/2) cos ((2π*ΔS/λ)/2) =2A cos (π*ΔS/λ) sin ((ωt+Φ₀).

To simplify computation, for instance, let variable t=0, then the mathematical equation will be

Y=2A cos (π*ΔS/λ) sin (Φ₀).

Because the luminance of the light interference fringe at point P has a positive correlation with wave propagation energy, the equation can be further simplified to the following:

Y=A* cos (π*ΔS/λ) sin (Φ₀)

If we set aberration ΔS equal to variable x, the function of luminance and aberration is the following:

f(x)=A* cos (π/λ*x)* sin (Φ₀).

This function is used as the light interference signal generating function.

To generate the initial state of a light interference signal the following difference equations are used:

x₁=A* cos (π/λ*x₀)* sin (Φ₀)+y₀

y₁=−x₀

To generate the sequential random numbers to be used in creating the ciphertext, the following two equations are used:

xₙ₊₁=A* cos (π/λ*xₙ)* sin (Φ₀)+yₙ

yₙ₊₁=−xₙ

Here, n=1,2,3, . . . , and yₙ is a feed-back signal based on the previous element of the random number stream.

Thus, a light interference signal generator used to generate a stream of random numbers used in creating the ciphertext or deciphering the ciphertext can be determined by the two equations above.

When inputs A, λ, Φ₀ and x₀, y₀ for initial values of xₙ and yₙ are input into a light interference signal generator, the aberration xₙ will change dynamically, and the luminance of light interference fringe xₙ₊₁ will be output as stream of random numbers (x₁, x₂, x₃, . . . ) by the light interference signal generator, based on the initial state values input into the light interference signal generator.

The cryptograph key used is ordinarily a 128 bit key. If the key is smaller, the key buffer will be filled by a repeat of the cryptograph key until the key buffer is filled at 128 bit. The cryptograph key is 128 bit, if it is segmented by 32 bit, it will generate four sub keys (K1, K2, K3, K4), which are used with different equations to change the sub keys to amplitude A, wavelength λ, initial phase Φ₀, and aberration x₀ of digital optical signal. Here, the A, λ, Φ₀ and x₀ are floating point data.

For instance, the range of values used in the light interference signal generator could be the following ranges:

0.90000000000<=A<1.00000000000

0.50000000000<=λ<0.60000000000

8.00000000000<=Φ₀<9.00000000000

0.80000000000<=x₀<0.90000000000

The equations in the key converter can be linear equations, or any other relatively quickly calculated equation. One example of a key conversion process can be expressed as the following code:

begin

tmp=(double) K1/π;

A=0.9+(tmp−(int) tmp)*0.1;

tmp=(double) K2/π;

λ=0.5+(tmp−(int) tmp)*0.1;

tmp=(double) K3/π;

Φ₀=8.0+(tmp−(int) tmp);

tmp=(double) K4/π;

x₀=0.8+(tmp−(int) tmp)*0.1;

end

This uses the four different 32 bit sub keys from the 128 bit key. The sub keys are then used to set the initial states of the light interference generator.

In addition, initial value y₀ of feedback signal yₙ can be 0.0, or any other convenient value.

An example of the process follows. The plaintext consists of a stream of data (m₁, m₂, m₃, . . . ) and a random stream of data (x₁, x₂, x₃, . . . ) is generated by the light interference signal generator. The ciphertext stream of data (c₁, c₂, c₃, . . . ) is generated by an XOR (exclusive OR) operation between the plaintext stream of data and the random stream of data generated by the light interference signal generator, on an element by element basis. In other words, an element of the ciphertext is generated by an XOR operation between the associated elements of the plaintext and the random stream of data generated by the light interference signal generator, as follows:

For encrypted element cᵢ of the ciphertext, cᵢ=mᵢ XOR xᵢ (for i=1,2,3, . . . ).

To decipher the ciphertext, the ciphertext stream of data (c₁, c₂, c₃, . . . ) is used, and the random stream data (x₁, x₂, x₃, . . . ) is again generated again by a light interference signal generator. Because the same initial states are used in the light interference signal generator, the random stream of data will be the same. The plaintext stream of data (m₁, m₂, m₃, . . . ) is recovered by an XOR (exclusive OR) operation between the ciphertext stream data and the random stream of data generated by the light interference signal generator using the same initial conditions for the two optical signals. The decrypted plaintext, then, is determined as follows:

For decrypted element (plaintext element) mᵢ of the plaintext, mᵢ=cᵢ XOR xᵢ (for i=1,2,3, . . . ).

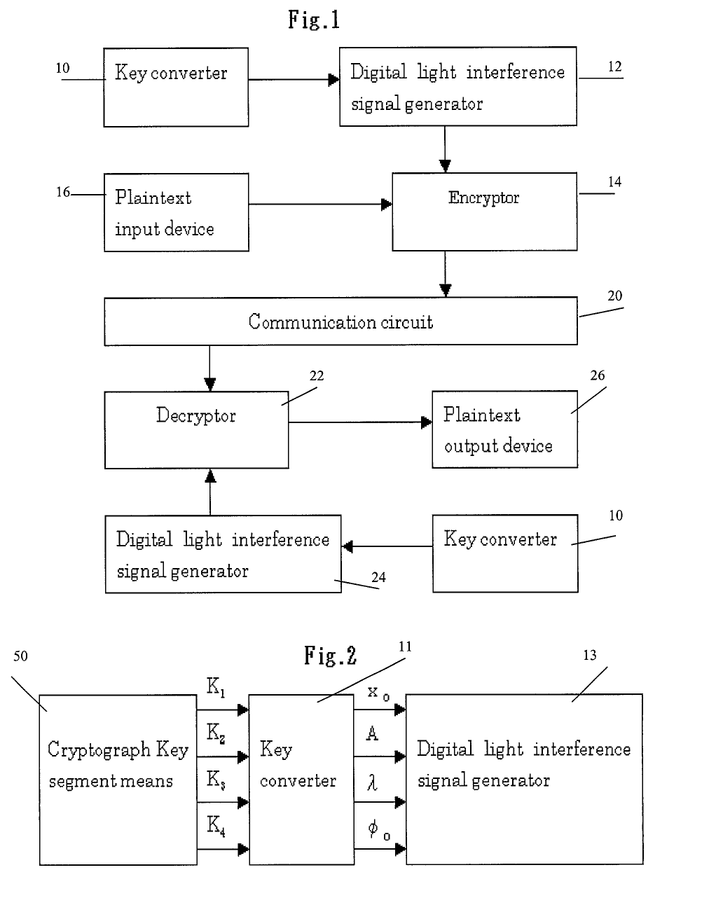

FIG. 1 is a functional block diagram of the encryption and decryption system. In the process of encryption, the system segments and converts the cryptograph key 10 into the initial values of a light interference signal, then inputs those values into a digital light interference signal generator 12. The generator outputs the luminance of the light interference fringe as a random number stream into the encryptor 14, which then encrypts the stream data from the plaintext input device 16, and finally encrypted data is output into the communication circuit 20.

The decryption process is similar to the encryption process, with the only difference being difference is that the encrypted stream data input into decryptor 22, then decrypted with random number from digital light interference signal generator 24, the decrypted data will be output into the plaintext output device 26.

FIG. 2 is a diagram showing a cryptograph key segment 50 and the conversion process. The maximum length of the cryptograph key is 128 bit, if the key is segmented by 32 bit, four sub keys (K₁, K₂, K₃, K₄) are generated, key converter 11 then uses different equations to change the sub keys to amplitude A, wavelength λ, initial phase Φ₀, and aberration x₀ of digital optical signal. The four sub keys are then input into the digital light interference signal generator 13.

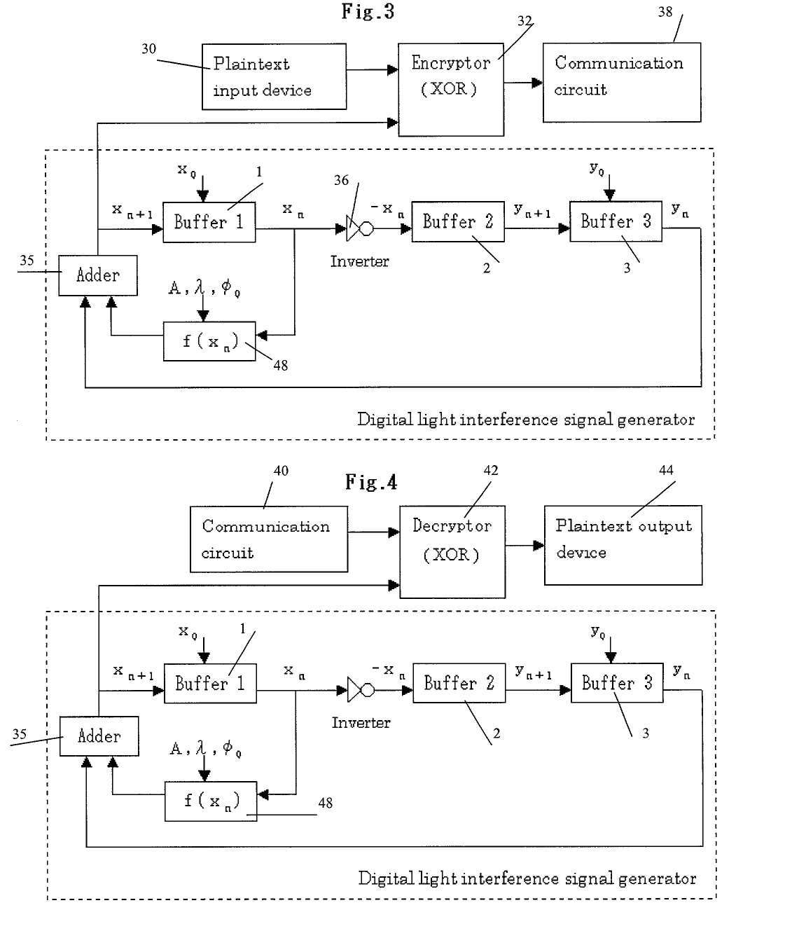

FIG. 3 is a diagram showing the encryption process. A stream of data from the plaintext input device 30 is input into the encryptor 32. Aberration x₀, amplitudes A, wavelengths λ,initial phases Φ₀ from the cryptograph key converter are set as initial values. These values are input into light interference signal generating function f(xₙ) 48, the result calculated by f(xₙ) plus feedback signal y₀ by the adder 35, and the new result input into the encryptor as xₙ₊₁. In the encryptor, data mₙ₊₁ from plaintext stream data are computed with xₙ₊₁ by XOR operations, then encrypted data will be outputted into the communication circuit 38 as ciphertext element cₙ₊₁. Meanwhile, xₙ₊₁ is also transferred into buffer 1 as the next xₙ in f(xₙ). xₙ is changed to −xₙ in an inverter 36, and transferred to buffer 2, then transferred into buffer 3 as feedback signal yₙ₊₁. yₙ₊₁ will be used as yₙ in next computation process, completing the feedback loop.

FIG. 4 is a diagram showing the decryption process. The decryption process is similar to the encryption process, the only difference being that data element cₙ₊₁ in encrypted stream data from the communication circuit 40 is input into the decryptor 42 instead of the plaintext. The ciphertext is then combined with data xₙ₊₁ in the random number stream data from the digital light interference signal generator by a series of XOR operations, and the decrypted data elements are output into the plantext output device 44.

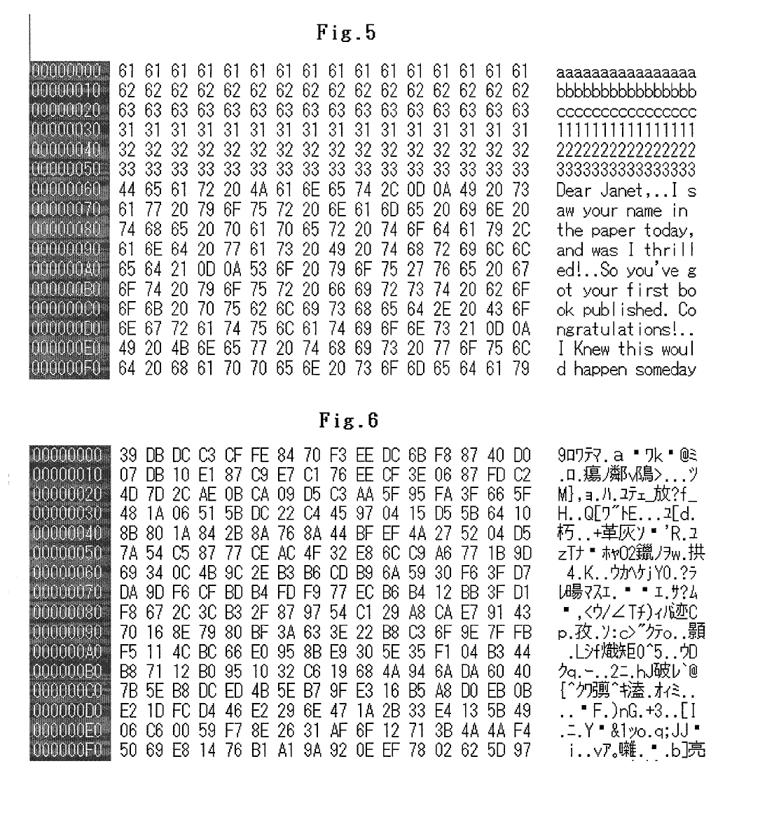

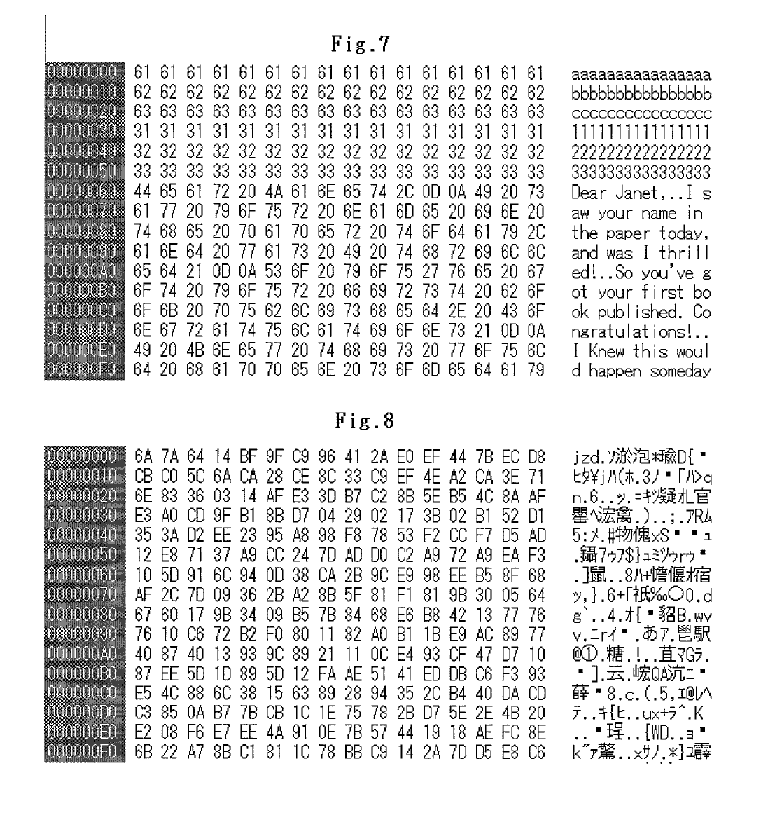

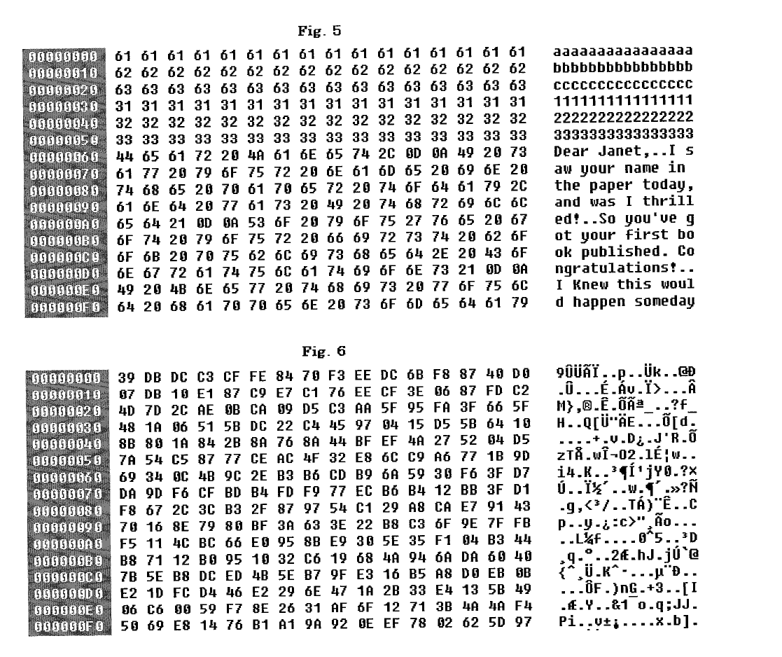

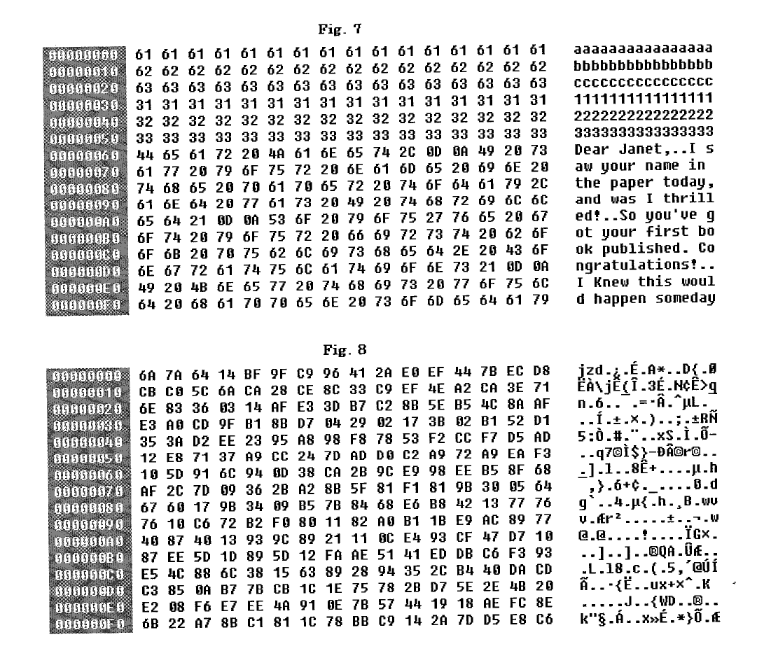

To verify the properties of the system, a software program was successfully developed using the invention. Sample data were encrypted and decrypted. FIG. 5 and FIG. 7 show plaintext data. FIG. 6 shows encrypted data generated using the invention and a first cryptograph key, key1. FIG. 8 also shows encrypted data, generated using the invention and a second cryptograph key, key2.

While the preferred embodiments of the present invention have been illustrated and described, it will be understood by those of ordinary skill in the art that changes and other modifications can be made without departing from the invention in its broader aspects. Various features of the present invention are set forth in the following claims.

What is claimed is:

1. A method of generating a key for encryption or decryption of data comprising:
a) generating parameters for a digital light interference signal generator;
b) using said digital light interference signal generator to generate a series of luminance measurements at an interference fringe;
c) converting said measurements into a series of numbers; and
d) generating a key for encryption or decryption of data based on said series of numbers.

2. A method of generating a key for encryption or decryption of data comprising:
a) generating parameters for a two optical signals;
b) using a light interference measuring device to generate a series of luminance measurements at an interference fringe of said two optical signals;
c) converting said measurements into a series of numbers; and
d) generating a key for encryption or decryption of data based on said series of numbers.

3. A cryptographic system comprising:
1) software or hardware for segmenting and converting a cryptograph key into two digital optical signals with amplitudes, wavelengths, and initial phases, and an initial aberration (optical path length difference) at a point P where the two digital optical signals meet;
2) software or hardware for encrypting and decrypting using a digital light interference signal generator used to dynamically generate aberration value changes, with the luminance of a light interference fringe at point P changing as the aberration changes generating a series of random numbers;
3) software or hardware for using the series generating a ciphertext by XOR operations between the plaintext and the random numbers generated by the digital light interference signal generator;

4. The system of claim 3 wherein the ciphertext is also deciphered using a process similar to the encryption process, with the only difference being that the plaintext is recovered by XOR operations between the ciphertext and the random numbers.

5. The system of claim 3 wherein the cryptograph key is segmented and converted into amplitudes, wavelengths, initial phases, and initial aberration of digital optical signals comprising a means for adjusting the mathematical precision of the amplitudes, wavelengths, initial phases, and aberration to get the sequence of random numbers from the digital light interference signal generator.

6. The system of claim 3 wherein the method of encrypting or decrypting the data comprises the step of:
a) repeating until filling cryptograph key into a key buffer until the key is 128 bits long;
b) segmenting the key buffer into 32 bit sub keys;
c) converting the sub keys to amplitudes A, wavelengths λ, initial phases Φ₀, and initial aberration x₀ of a digital optical signal;
d) calculating an initial value y₀ to be used as an initial value of yₙ as a feed back signal;
e) in order to generate an initial state of a light interference using equations x₁=A* cos (π/λ*x₀)* sin (Φ₀)+y₀ and y₁=−x₀;
f) in order to generate the sequential random numbers using equations xₙ₊₁=A* cos (π/λ*xₙ)* sin (Φ₀)+yₙ and yₙ₊₁=−xₙ.
